(19) United States
(12) Patent Application Publication
(10) Pub. No.: US 2006/0005462 A1
(43) Pub. Date: Jan. 12, 2006

(54) Devices and methods for monitoring and controlling arthropods

(76) Inventors: James B. Ballard, Medford, NJ (US); Amy O'Shea, Jalisco (MX)

Correspondence Address: PATENT ADMINISTRATOR;FMC CORPORATION, 1735 MARKET STREET, PHILADELPHIA, PA, 19103, US

(21) Appl. No.: 11/170,842

(22) Filed: Jun. 30, 2005

Related U.S. Application Data
(60) Provisional application No. 60/586,309, filed on Jul. 8, 2004.

(51) Int. Cl. A01M 1/20; A01M 1/02

(52) U.S. Cl. 43/132.1; 43/131

(57) ABSTRACT

The present invention provides an arthropod monitoring or baiting station that may be adapted for use in above-ground applications. The station comprises a primary housing that may be coupled to a secondary housing which is configured such that a major area portion of the secondary housing extends beyond the primary housing. An operator may couple, remove, and/or replace different secondary housings to the primary housing to provide an operator increased flexibility in monitoring or controlling an arthropod population.

### FIELD OF THE INVENTION

The present invention relates to the monitoring and/or controlling of arthropods such as termites and, in particular, to devices and methods that may be adapted for use in above-ground applications.

### BACKGROUND OF THE INVENTION

Termites are well known throughout most areas of the world as insects that attack and destroy wooden structures. Subterranean termites most often enter structures from the surrounding soil to feed on wood or other cellulosic material of the structure and its contents. Many methods for killing termites have been employed over the years. One such method involves applying a toxicant (i.e., a material that kills or repels termites) to the soil in the vicinity of a structure that is to be protected from termites. Not only is this type of treatment labor intensive and raises issues about soil contamination, but the possibility exists that the application will not produce an adequate barrier to termite infestation.

Another approach to termite control involves the insertion of wooden stakes or some other suitable termite bait material into the soil around the periphery of the structure to be protected, monitoring the stakes for infestation, and then applying a toxicant to the soil only in those areas in which infestation is observed. This approach minimizes use of the toxicant, yet presents other problems. The bait stakes, for example, do not provide a continuous barrier around the structure, as they typically occupy limited area and, moreover, are separated from one another by a distance on the order of feet or even yards. Termite populations located in the soil might find it difficult to locate the bait stakes, especially if they are widely spaced. Also, subsequent removal and replacement of the bait stakes can disrupt the system of passageways leading to the stakes that termites may have constructed and, in turn, can disrupt the flow of termites to a stake upon stake re-insertion.

These problems are said to be addressed by U.S. Pat. No. 5,329,726, which discloses both subterranean and above-ground devices that contain a removable bait cartridge within a permanently fixed housing. The bait cartridge is said to be removably received within the housing in a close fitting relationship, such that if termite activity is detected a pesticide-containing cartridge corresponding identically to the structure of the bait cartridge may be substituted for the bait cartridge within the housing. Fixedly positioning the housing during replacement and substitution of the cartridges is said to minimize disruption to pre-existing passageways established by termites between their nest and the housing.

U.S. Pat. No. 6,058,646 discloses an above ground station involving a primary housing and connectable secondary housings that may be attached to the primary housing in a stacked configuration. The addition of housings to the primary housing is said not to disturb the pre-existing network of passageways established between the termite colony and the primary housing.

Despite the availability of such devices and methods, there remains a need to, for example and without limitation, offer systems that provide a Pest Management Professional (PMP) or other operator various options for monitoring and controlling arthropods that cause little disturbance to the arthropods feeding in the station. An operator will often encounter different structures suffering from different arthropod infestation situations from site to site and may require flexibility in addressing each situation.

### SUMMARY OF THE INVENTION

In one aspect, the present invention provides arthropod stations that comprise a primary housing that substantially defines an interior volume and has at least one locator orifice adapted for placement proximate to a region of suspected arthropod activity. The station further comprises at least one secondary housing that substantially defines an interior volume and has at least one opening in communication with the interior volume that includes a material capable of being consumed by arthropods, a material capable of being penetrated by arthropods, a material capable of being transported by arthropods, or a material capable of killing arthropods. The primary housing includes a coupling orifice adapted for coupling with a portion of the secondary housing that includes the opening and is configured such that a major area portion of the secondary housing extends beyond the primary housing. Either the opening in the secondary housing is adapted for receipt of a portion of the primary housing that includes the coupling orifice, or the coupling orifice in the primary housing is adapted for receipt of a portion of the secondary housing that includes the opening.

The present invention also provides methods for positioning arthropod stations adjacent to a region suspected of arthropod infestation. Also provided are methods for monitoring the stations of the invention for arthropod activity. Such methods comprise, for example, identifying an arthropod station of the present invention and determining the extent to which the material in the secondary housing has been removed by arthropods, and can further include coupling and/or replacing different secondary housings to a coupling orifice in the primary housing.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings shows a certain preferred embodiment. It is understood, however, that the invention is not limited to the specific methods and devices disclosed. In the drawings:

FIG. 1 shows a perspective view of a monitoring/baiting station according to the present invention.

FIG. 2 shows a perspective view of another embodiment of the present invention.

### DETAILED DESCRIPTION OF ILLUSTRATIVE EMBODIMENTS

The present invention provides stations and methods for monitoring and controlling arthropods. As used herein, the term “monitoring” is intended to mean watching, inspecting, observing, or checking a person or thing, particularly an arthropod such as a termite. Thus, a device that enables its user to simply determine whether or not termites are present in an area of interest is deemed to be a monitoring device, irrespective of whether or not that device enables its user to perform some additional task such as, for example, killing the termites.

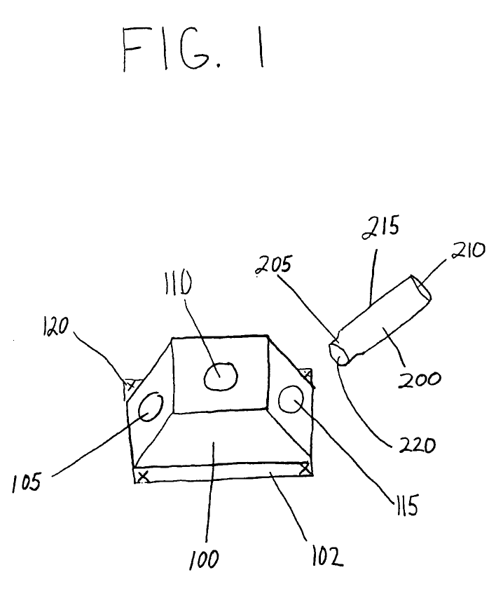

FIG. 1 shows a perspective view of a preferred monitoring/baiting station according to the present invention comprising a primary housing 100 that substantially defines an interior (not shown). The primary housing may be fabricated from any of a variety of materials having suitable strength and rigidity including, without limitation, plastic (i.e., synthetic polymer), wood, plaster, concrete, asphalt, tile, brick, masonry, ceramic, metal, rigid polymeric foam, composites of two or more materials, and laminates of suitable sheet materials. It is preferred that they be fabricated from rigid or flexible plastic, preferably polyethylene or polystyrene, and more preferably polypropylene. In certain embodiments of the present invention, at least a portion of the primary housing may be made of a substantially transparent material such as glass or synthetic polymer to facilitate inspection of the interior.

The primary housing has at least one locator orifice (not shown) that is adapted for placement proximate to a region of suspected arthropod activity. For example, the primary housing 100 may be positioned adjacent to a target surface, such as timber, such that the locator orifice is proximate to the surface and suitable for ingress or egress by an arthropod with respect to the interior portion of the primary housing. The locator orifice may be an open end of the primary housing or may constitute a slot or aperture in the exterior of the primary housing.

The primary housing 100 may be removably positioned on the target surface or permanently affixed to the surface. As shown in FIG. 1, the primary housing may include a flange 102 having positioning openings 120 for positioning the primary housing to a target surface with the use of screws or nails. Alternatively, the primary housing may be glued or otherwise bonded to a target surface.

In certain embodiments, the primary housing may be positioned on a structure containing an active termite mud tube. In such an embodiment, the primary housing 100 may be positioned on the structure so that the termite mud tube opening(s) align with the locator orifice of the primary housing. For example, part of the termite mud tube may be broken away to allow alignment of the locator orifice of the primary housing with the termite mud tube. The termites typically will rebuild the termite mud tube into the primary housing and termites passing through the termite mud tube will also pass through the locator orifice and into the interior of the primary housing.

The interior of the primary housing may contain materials capable of being consumed by arthropods, materials capable of being penetrated by arthropods, materials capable of being transported by arthropods, and/or materials capable of killing arthropods. Representative materials capable of being consumed by arthropods include cellulosic materials such as wood, cardboard (with or without wax treatment), fiberboard, paper, and sawdust. Typically, materials capable of being consumed by arthropods, as used herein, refer to materials that are not toxic, i.e. not capable of killing arthropods. Preferred materials of this type include wood and sawdust. In other embodiments, the material capable of being consumed by termites comprises a composition as disclosed in U.S. Pat. No. 5,573,760, which is incorporated herein by reference in its entirety. The materials may be used in the present invention in various forms, including, but not limited to, particles, pellets, granules, disks, or combination thereof, and may be contained in bags or pouches that are made of a material capable of being consumed by arthropods.

Representative materials capable of being penetrated by arthropods include polymeric foams such polystyrene foam, chalk, sponge material, and wood. Representative materials capable of being transported by arthropods include polyurethane and chalk. Representative materials capable of killing arthropods include but are not limited to, slow acting toxicants such as sulfluramid, hydramethylnon, avermectin, spinosad, nicotinoids (such as imidacloprid), fipronil, chlorfenapyr, indoxacarb, borates, insect growth regulators, chitin inhibitors (such as hexaflumuron, lupenuron, and diflubenzuron), halofenicide, isothiozalone, sulfotine, juvenile hormone analogs, biological agents (e.g., spores, mycelium, mites, nematodes, or toxins), pyrethroids, protazoacides, and anti-bacterial agents. Preferred materials include chitin inhibitors.

The interior portion of the primary housing may also be empty or could include water (and, optionally, a gelling agent to retain the water) or a device that emits a signal when an arthropod is present within the interior portion of the housing. In addition, the primary housing may have a minimal interior portion and serve primarily as a coupling platform for a secondary housing 200.

The arthropod station of the present invention also includes at least one secondary housing 200. As exemplified by secondary housing 200, secondary housings according to the invention can include a first end element 205, a second end element 210, and a lateral wall 215 extending between the first end element and the second end element that substantially defines an interior portion. The secondary housing has at least one opening 220 that is in communication with the interior volume of the secondary housing and is suitable for ingress or egress by an arthropod.

The secondary housing may be fabricated from any of a variety of materials, including, without limitation, plastic (i.e., synthetic polymer), wood, plaster, concrete, asphalt, tile, brick, masonry, ceramic, metal, rigid polymeric foam, composites of two or more materials, and laminates of suitable sheet materials. It is preferred that they be fabricated from rigid or flexible plastic, preferably polyethylene or polystyrene, and more preferably polypropylene. In certain embodiments of the present invention, at least a portion of the secondary housing may be made of a substantially transparent material such as glass or synthetic polymer to facilitate inspection of the interior.

As with the primary housing, the interior of the secondary housing may be constructed of or contain materials capable of being consumed by arthropods, materials capable of being penetrated by arthropods, materials capable of being transported by arthropods, and/or materials capable of killing arthropods.

The primary housing 100 also includes at least one coupling orifice, as exemplified by orifices 105, 110, and 115 in FIG. 1. These coupling orifices are adapted for coupling with a portion of the secondary housing that includes opening 220. In this manner, arthropods are able to travel between the interior of the primary housing and the interior of the secondary housing. As exemplified in FIG. 1, coupling orifice 115 is adapted to receive first end 205 of secondary housing 200, such that first end 205 of secondary housing 200 is received substantially within the coupling orifice 115 of the primary housing 100. The first end 205 may be removably coupled to coupling orifice 115 or permanently coupled thereto. Any of the known structures for removable coupling may be used. First end 205, for example, can snap, turn, push on, and/or screw into the coupling orifice 115. In other embodiments, first end 205 and the interior of the coupling orifice 115 may contain complimentary threaded elements (not shown).

Alternatively, the first end may be permanently coupled to the coupling orifice 115. Any of the known structures for permanent coupling may be used, such as, for example, gluing or otherwise bonding the secondary housing to the coupling orifice 115 of the primary housing 100, or making first end 205 integral with the coupling orifice of the primary housing.

It is to be understood that the opening 220 in the secondary housing may also be adapted to receive a portion of the primary housing including the coupling orifice, such that the coupling orifice 115 of secondary housing 200 is received substantially within the opening 220 of the secondary housing. In other embodiments, the portions of the primary housing and secondary housing are not received within one another, but abut against each other such that the coupling orifice 115 of the primary housing is aligned with the opening 220 in the secondary housing to allow for the ingress or egress of an arthropod.

As shown in FIG. 1, a major area portion of the secondary housing extends beyond the primary housing and does not contact the exterior surface of the primary housing. In this respect, a major area portion of the secondary housing constitutes about 75%, preferably 85%, more preferably 90%, and even more preferably 95% of the secondary housing. In this manner, the present invention provides enhanced inspection capability where the secondary housing is substantially transparent and reduces disturbance to the primary housing and its interior. In addition, this allows a PMP to design secondary housings in numerous sizes and shapes to accommodate a wide range of structures to be monitored. In other words, the shape and orientation of the secondary housing is not limited by the shape and size of the primary housing. The secondary housing can be coupled to the coupling orifice of the primary housing at various angles as well.

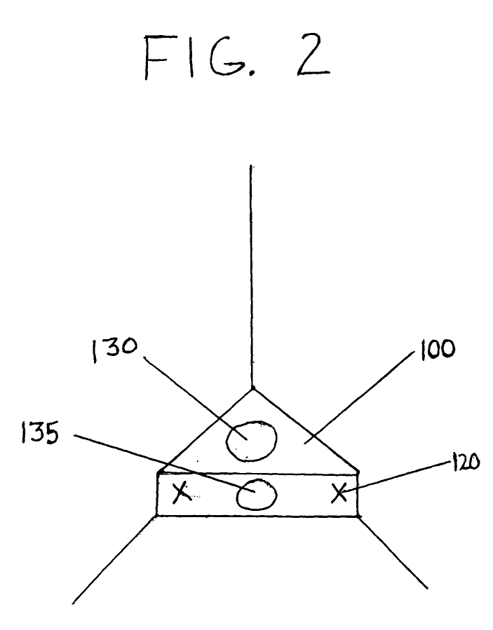

For example, FIG. 2 shows a station that may be particularly suited for use in corners or for use between otherwise intersecting structures. In such an embodiment, the primary housing 100 has a wedge shape that may be situated, for example, in the corner of a room, and may include positioning openings 120. The primary housing may include coupling orifices 130 and 135 on its top and/or side surfaces. Such an embodiment is yet another example of the flexibility offered by the present invention.

In other embodiments, an additional secondary housing may be coupled to an existing secondary housing. For example, in connection with the embodiment of FIG. 1, the additional secondary housing may be coupled to second end 210 of secondary housing 200, where the second end 210 has an opening in communication with the interior of secondary housing 200.

As will be recognized, there are a variety of secondary housings that can be used in accordance with the present invention and, thus, quite a number of possible ways of combining these secondary housings with the primary housing in accordance with the present invention. Combinations can be achieved independently by, for example, removing all of the secondary housings from the primary housing and then replacing them with entirely different secondary housings, or through a more transitional process by, for example, removing and replacing only one of three secondary housings.

As evident from the disclosure herein, the present invention provides a PMP or other operator with various alternatives to monitor and/or control an arthropod population. The secondary housings that can be coupled to the primary housing provide an operator with increased flexibility in treating any particular arthropod infestation situation. The use of multiple secondary housings also make it possible to provide a relatively large volume of monitoring and/or baiting material in response to heavy feeding conditions. Moreover, the separate and independent configuration of the multiple secondary housings and the various functions each secondary housing can serve provide many alternatives for minimizing interruption and disturbance of arthropods feeding within the target structure or within the primary housing starting at the time of installation and throughout the monitoring and/or controlling activities.

Generally, the primary housing is positioned adjacent to a region suspected to suffer from arthropod infestation. Such regions, include, without limitation, timber, termite mud tubes, sidewalks, baseboards, live and dead trees, drywall, and termite-infested wood.

Initially, it is preferred that a station of the invention comprise a primary housing and/or secondary housing that serves a monitoring function. For example, the primary or secondary housing may comprise a wooden block or another material that is attractive, non-toxic and/or nonrepellant to arthropods. The primary or secondary housing may be periodically inspected for arthropod activity. As previously disclosed, inspection is preferably accomplished by looking through a substantially transparent portion of the primary or secondary housing, but may also be performed by removing the primary or secondary housing and inspecting its interior.

Upon detection of arthropod activity within the primary housing, a secondary housing having a material capable of killing arthropods, i.e. a baiting secondary housing may be coupled to a coupling orifice of the primary housing. In those embodiments initially including a monitoring secondary housing, the secondary housing can be removed and replaced with a secondary housing having a material capable of killing arthropods, i.e. a baiting secondary housing. In other embodiments, upon detection of arthropod activity, an additional secondary housing may be coupled to a different coupling orifice 110 of the primary housing. In this manner, arthropods previously feeding or present within the primary housing or a pre-existing secondary housing will be relatively undisturbed upon the coupling of a new baiting secondary housing to the primary housing to provide control of the arthropod population. In heavy infestation areas, two or more baiting secondary housings can be coupled to the primary housing. In addition, the primary housing may initially be coupled to one or more baiting secondary housings, particularly if detection is not a primary concern or if an area is known to be infested with arthropods.

It is to be understood, however, that other combinations and selective coupling and replacement of secondary housings is contemplated within the scope of the present invention, as the flexibility offered by the present invention is one of its advantages. Indeed, the secondary housings and the materials therein may be used in any sequential arrangement and configuration that meets the needs of the PMP or other operator.

As is evident from the above examples, the secondary housings of the invention can be arranged in various combinations and substituted for one another depending on the particular arthropod infestation situation. The substitution of a secondary housing or the coupling of a secondary housing can be carried out without substantial disturbance to the arthropods already present within the station. In addition the removal or coupling of one secondary housing can take place without disturbance to another secondary housing and the arthropods that can be present therein.

The apparatus and methods herein can be combined with other methods and apparatus directed to monitoring and/or controlling other insect pests, such as ants. Those skilled in the art will appreciate that numerous changes and modifications can be made to the preferred embodiments of the invention and that such changes and modifications can be made without departing from the spirit of the invention. It is therefore intended that the appended claims cover all such equivalent variations as fall within the true spirit and scope of the invention.

What is claimed:

1. An arthropod station comprising:
a primary housing that substantially defines an interior volume and has at least one locator orifice adapted for placement proximate to a region of suspected arthropod activity, and
at least one secondary housing that substantially defines an interior volume and has at least one opening in communication with said interior volume, wherein:
said secondary housing includes a material capable of being consumed by arthropods, a material capable of being penetrated by arthropods, a material capable of being transported by arthropods, or a material capable of killing arthropods;
said primary housing includes at least one coupling orifice adapted to communicate with a portion of said secondary housing including said opening;
a major area portion of said secondary housing extends beyond said primary housing; and
either said opening in said secondary housing is adapted for receipt of a portion of said primary housing including said coupling orifice, or said coupling orifice is adapted for receipt of a portion of said secondary housing including said opening.

2. The station of claim 1 wherein:
said primary housing has an exterior surface defining an interior chamber;
said at least one locator orifice is in communication with said interior chamber; and
said at least one coupling orifice is disposed between the exterior surface and the interior chamber.

3. The station of claim 2 wherein the interior chamber of the primary housing includes a material capable of being consumed by arthropods, a material capable of being penetrated by arthropods, a material capable of being transported by arthropods, or a material capable of killing arthropods.

4. The station of claim 1 wherein said portion of said at least one secondary housing including said opening is removably received substantially within said at least one coupling orifice.

5. The station of claim 1 wherein said portion of said at least one secondary housing including said at least one opening is permanently affixed to said portion of said primary housing including said at least one coupling orifice.

6. The station of claim 1 wherein said at least one secondary housing defines a first end, a second end, and a lateral wall that substantially defines said interior volume and wherein said first end includes said at least one opening that is in communication with said interior volume and is removably received substantially within said at least one coupling orifice.

7. The station of claim 1 wherein said primary housing is substantially transparent.

8. The station of claim 1 wherein said at least one secondary housing is substantially transparent.

9. The station of claim 1 wherein said at least one secondary housing has a lateral cross-section substantially defining a closed surface shape.

10. A method comprising positioning at least one station of claim 1 adjacent to a region suspected to suffer from arthropod infestation.

11. The method of claim 10 further comprising inspecting said at least one station for arthropod activity.

12. The method of claim 11 further comprising coupling an additional secondary housing to said at least one coupling orifice of said primary housing.

13. The method of claim 11 further comprising removing said at least one secondary housing from said at least one coupling orifice of said primary housing.

14. The method of claim 13 further comprising coupling at least one additional secondary housing to said at least one coupling orifice in place of said removed secondary housing.

15. The method of claim 14 wherein said additional secondary housing includes a material capable of killing arthropods.
